(19) United States
(12) Patent Application Publication
(10) Pub. No.: US 2020/0167544 A1
(43) Pub. Date: May 28, 2020

(54) LINES UNLOCKING METHOD, A LINES UNLOCKING SYSTEM, AND A DISPLAY DEVICE

(71) Applicants: Chengdu BOE Optoelectronics Technology Co., Ltd., Chengdu (CN); BOE Technology Group Co., Ltd., Beijing (CN)

(72) Inventor: Qifeng LI, Beijing (CN)

(73) Assignees: Chengdu BOE Optoelectronics Technology Co., Ltd.; BOE Technology Group Co., Ltd.

(21) Appl. No.: 16/518,002

(22) Filed: Jul. 22, 2019

(30) Foreign Application Priority Data
Nov. 23, 2018 (CN) 201811406176.1

(51) Int. Cl. G06K 9/00

(52) U.S. Cl. CPC G06K 9/00013; G06K 9/00919

(57) ABSTRACT

The disclosure provides a the lines unlocking method, a lines unlocking system, and a display device, and the lines unlocking method includes: a touch pressure detector provides a driving chip with a first enabling signal, and a lines recognizing chip with a second enabling signal upon determining that the touch pressure detector is triggered; the driving chip drives the display screen to display an unlocking background image pre-stored in the driving chip, upon reception of the first enabling signal, where the unlocking background image indicates a position for lines unlocking; the lines recognizing chip acquires lines data upon reception of the second enabling signal, and provides a master controller with the acquired lines data; and the master controller compares the acquired lines data with pre-stored lines data upon reception of the acquired lines data to enable lines unlocking.

### CROSS-REFERENCE TO RELATED APPLICATION

This application claims priority to Chinese Patent Application No. 201811406176.1, filed on Nov. 23, 2018, which is hereby incorporated by reference in its entirety.

### FIELD

The present disclosure relates to the field of lines recognizing technologies, and particularly to a lines unlocking method, a lines unlocking system, and a display device.

### BACKGROUND

As the display technologies are advancing constantly, display screens with a narrow bezel or without any bezel have been increasingly favored, and in order to improve a screen to panel ratio, a lines unlocking technology has been commonly applied.

### SUMMARY

Embodiments of the disclosure provide a lines unlocking method, a lines unlocking system, and a display device so as to address the problems of a low response speed and high power consumption in lines unlocking below the display screen.

An embodiment of the disclosure provides a lines unlocking method including: providing, by a touch pressure detector, a driving chip with a first enabling signal, and a lines recognizing chip with a second enabling signal upon determining that the touch pressure detector is triggered; driving, by the driving chip, a display screen to display an unlocking background image pre-stored in the driving chip, upon reception of the first enabling signal, where the unlocking background image indicates a position for lines unlocking; acquiring, by the lines recognizing chip, lines data upon reception of the second enabling signal, and providing a master controller with the acquired lines data; and comparing, by the master controller, the acquired lines data with pre-stored lines data upon reception of the acquired lines data to enable lines unlocking.

In some embodiments, in the lines unlocking method above according to the embodiments of the disclosure, the determining that the touch pressure detector is triggered includes: when the display screen is unlocked, detecting, by the touch pressure detector, a change in pressure in real time; and determining that the touch pressure detector is triggered, upon determining that a value of the change in pressure is greater than a preset pressure threshold.

In some embodiments, in the lines unlocking method above according to the embodiments of the disclosure, driving, by the driving chip, the display screen to display the unlocking background image pre-stored in the driving chip includes: driving, by the driving chip, the display screen from a first brightness display mode to a second brightness display mode, where a second brightness value of the second brightness display mode is greater than a first brightness value of the first brightness display mode; and driving, by the driving chip, the display screen to display the unlocking background image pre-stored in the driving chip in the second brightness display mode.

In some embodiments, in the lines unlocking method above according to the embodiments of the disclosure, comparing, by the master controller, the acquired lines data with the pre-stored lines data upon reception of the acquired lines data to enable lines unlocking includes: comparing the acquired lines data with a plurality of sets of lines data pre-stored in the master controller; and enabling unlocking when the acquired lines data match successfully with one of the plurality of pre-stored sets of lines data.

In some embodiments, in the lines unlocking method above according to the embodiments of the disclosure, comparing the acquired lines data with the plurality of sets of lines data pre-stored in the master controller includes: comparing the acquired lines data with the plurality of pre-stored sets of lines data in a descending order of the numbers of times that the plurality of pre-stored sets of lines data match successfully with previously acquired lines data; and when the acquired lines data match successfully with one of the plurality of pre-stored sets of lines data, stopping the acquired lines data from being compared with the other pre-stored sets of lines data.

In some embodiments, in the lines unlocking method above according to the embodiments of the disclosure, after unlocking is enabled when the acquired lines data match successfully with one of the pre-stored sets of lines data, the method further includes: updating the numbers of times that the plurality of pre-stored sets of lines data match successfully with previously acquired lines data; and sorting the numbers of times that the plurality of pre-stored sets of lines data match successfully with previously acquired lines data, in a descending order.

In another aspect, an embodiment of the disclosure provides a lines unlocking system including: a touch pressure detector, a driving chip, a lines recognizing chip, and a master controller, where: the touch pressure detector is configured to provide the driving chip with a first enabling signal, and the lines recognizing chip with a second enabling signal upon determining that the touch pressure detector is triggered; the driving chip is configured to drive a display screen to display an unlocking background image pre-stored in the driving chip, upon reception of the first enabling signal, where the unlocking background image indicates a position for lines unlocking; the lines recognizing chip is configured to acquire lines data upon reception of the second enabling signal, and to provide the master controller with the acquired lines data; and the master controller is configured to compare the acquired lines data with pre-stored lines data upon reception of the acquired lines data to enable lines unlocking.

In some embodiments, in the lines unlocking system above according to the embodiments of the disclosure, the touch pressure detector is configured: when the display screen is unlocked, to detect a change in pressure in real time; and to determine that the touch pressure detector is triggered, upon determining that a value of the change in pressure is greater than a preset pressure threshold.

In some embodiments, in the lines unlocking system above according to the embodiment of the disclosure, the driving chip is configured: to drive the display screen from a first brightness display mode to a second brightness display mode, where a second brightness value of the second brightness display mode is greater than a first brightness value of the first brightness display mode; and to drive the display screen to display the unlocking background image pre-stored in the driving chip in the second brightness display mode.

In some embodiments, in the lines unlocking system above according to the embodiment of the disclosure, the master controller is configured: to compare the acquired lines data with a plurality of sets of lines data pre-stored in the master controller; and to enable unlocking when the acquired lines data match successfully with one of the plurality of pre-stored sets of lines data.

In some embodiments, in the lines unlocking system above according to the embodiment of the disclosure, the master controller is further configured: to compare the acquired lines data with the plurality of pre-stored sets of lines data in a descending order of the numbers of times that the plurality of pre-stored sets of lines data match successfully with previously acquired lines data; and when the acquired lines data match successfully with one of the plurality of pre-stored sets of lines data, to stop the acquired lines data from being compared with the other pre-stored sets of lines data.

In some embodiments, in the lines unlocking system above according to the embodiments of the disclosure, the master controller is further configured: to update the numbers of times that the plurality of pre-stored sets of lines data match successfully with previously acquired lines data after the acquired lines data match successfully with one of the plurality of pre-stored sets of lines data; and to sort the numbers of times that the plurality of pre-stored sets of lines data match successfully with previously acquired lines data, in a descending order.

In some embodiments, in the lines unlocking system above according to the embodiments of the disclosure, the lines recognizing chip is connected with the master controller via a Serial Peripheral Interface (SPI).

In some embodiments, in the lines unlocking system above according to the embodiment of the disclosure, the touch pressure detector is connected respectively with the driving chip and the lines recognizing chip via an enabling signal interface.

In another aspect, an embodiment of the disclosure further provides a display device including the lines unlocking system above according to any one of the embodiments above of the embodiment of the disclosure.

### BRIEF DESCRIPTION OF THE DRAWINGS

In order to more clearly illustrate the technical solutions in the embodiments of the present disclosure, the following drawings will be briefly described in the description of the embodiments. Apparently, the drawings in the following description are only some of the embodiments of the present disclosure, and those skilled in the art can also obtain other drawings based on these drawings without any creative labor.

FIG. 1 is a schematic structural diagram of the lines recognizing system in the prior art.

FIG. 2 is a flow chart of a lines recognizing method according to an embodiment of the disclosure.

FIG. 3 is a schematic structural diagram of a lines recognizing system according to an embodiment of the disclosure.

FIG. 4 is a schematic structural diagram of a plurality of sets of lines data, which are sorted, according to an embodiment of the disclosure.

### DETAILED DESCRIPTION OF THE EMBODIMENTS

In the related art, a lines recognizing system below a display screen communicates with a master controller through a touch pressure detector, awakes a driving chip through the master controller, and transmits a background image required for lines unlocking to the driving chip, and also awakes a lines recognizing chip through a main board to acquire lines data, which are compared at the main board for an unlocking operation. In the process above, the master controller interactively communicates repeatedly with the driving chip and the lines recognizing chip, and this communication process is complicated, has a low response speed, and consumes power of the master controller.

Accordingly it is highly desirable for those skilled in the art to improve a response speed, and to lower power consumption, in lines unlocking below the display screen.

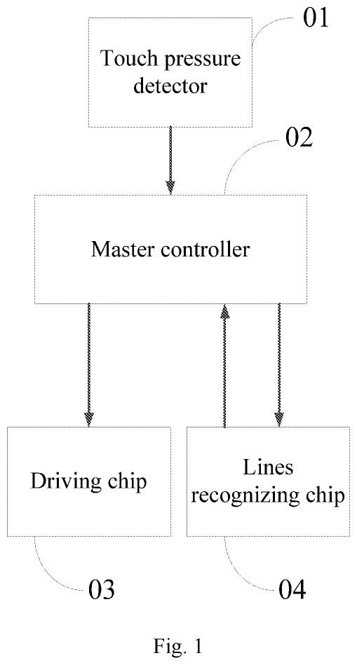

As illustrated in FIG. 1, in the related art, a lines unlocking system includes a touch pressure detector 01, a master controller 02, a driving chip 03, and a lines recognizing chip 04. The touch pressure detector 01 detects a change in pressure due to a touch. The touch pressure detector 01 communicates with the master controller 02 so that the master controller 02 enters a lines unlocking mode. The master controller 02 sends an enabling signal to the driving chip 03, and provides the driving chip 03 an unlocking background image indicating a lines recognizing position, after the driving chip 03 is awoken. The master controller 02 further sends an enabling signal to the lines recognizing chip 04 to awake the lines recognizing chip 04. The lines recognizing chip 04 acquires lines data and provides the master controller 02 with the acquired lines data. The master controller 02 performs lines comparison and unlocking. In this process, the master controller 02 communicates repeatedly with the driving chip 03 and the lines recognizing chip 04, thus prolonging a period of time for lines unlocking, and increasing power consumption of the master controller 02.

In order to address the problem above in the related art, the embodiments of the disclosure provide a lines unlocking method, a lines unlocking system, and a display device.

Particular implementations of a lines unlocking method, a lines unlocking system, and a display device according to the embodiments of the disclosure will be described below in details with reference to the drawings.

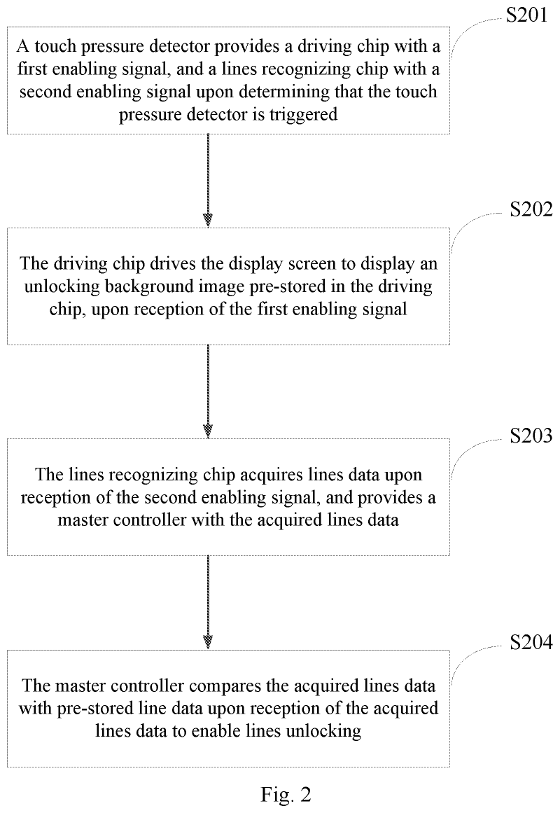

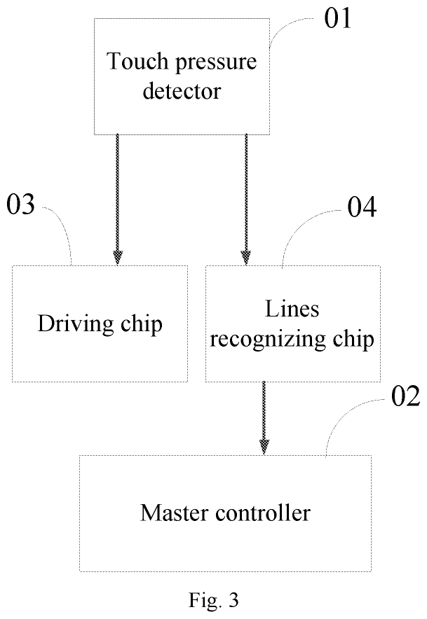

As illustrated in FIG. 2 and FIG. 3, a lines unlocking method according to an embodiment of the disclosure includes the following operations.

In the operation S201, a touch pressure detector 01 provides a driving chip 03 with a first enabling signal, and a lines recognizing chip 04 with a second enabling signal upon determining that the touch pressure detector is triggered.

Here the driving chip is awoken by the first enabling signal to drive a display screen to perform a series of lines recognizing operations. The lines recognizing chip is awoken by the second enabling signal to acquire lines data.

In some embodiments, a recognized object having lines is a hand, thus the lines recognized by the lines recognizing chip may be skin lines, such as a palm print, a fingerprint, etc.; or, a recognized object having lines is an object, thus the lines recognized by the lines recognizing chip may be a contour of the object, a pattern of the object, etc. That is, the lines data associated with all the living things and/or the non-living body having a certain lines shall fall into the claimed scope of the disclosure, and the embodiments of the disclosure will not be limited thereto.

In the operation S202, the driving chip 03 drives the display screen to display an unlocking background image pre-stored in the driving chip 03, upon reception of the first enabling signal, where the unlocking background image indicates a position for lines unlocking.

Here the unlocking background image may occupy only a part of the area on the display screen, that is, only a part of the area on the display screen may be lightened as a lines recognizing area; or the unlocking background image may occupy a entire display screen, that is, the entire area on the display screen may be lightened, and include an indicating pattern to indicate the position of a lines recognizing area to a user. These are only a part of embodiments of the lines background image, but any driving and display modes of the unlocking background image for lines recognition shall fall into the claimed scope of the disclosure, and the embodiment of the disclosure will not be limited thereto.

In the operation S203, the lines recognizing chip 04 acquires lines data, and provides the master controller 02 with the acquired lines data, upon reception of the second enabling signal.

The lines recognizing chip obtains the lines data transmitted by a lines acquiring component arranged in the display screen, where the lines acquiring component can be an optical lines acquiring component, although the embodiment of the disclosure will not be limited thereto.

It shall be noted that although the touch pressure detector provides the driving chip with the first enabling signal, and the lines recognizing chip with the second enabling signal, the user places a lines at the position for lines unlocking in the unlocking background image pre-stored in the driving chip, and the lines recognizing chip acquires the lines data only after the display screen is driven to display the unlocking background image. So even if the driving chip and the lines recognizing chip receive their respective enabling signals, the operation S203 will be further performed only after the operation S202 is performed.

In the operation S204, the master controller 02 compares the acquired lines data with pre-stored lines data upon reception of the lines data to enable lines unlocking.

The master controller compares the acquired lines data with a plurality of sets of lines data pre-stored in the master controller, and unlocks the display device when the acquired lines data match successfully with any one of the plurality of pre-stored sets of lines data.

In the lines unlocking method according to the embodiments of the disclosure, a touch pressure detector provides a driving chip with a first enabling signal, and a lines recognizing chip with a second enabling signal upon determining that the touch pressure detector is triggered; the driving chip drives the display screen to display an unlocking background image pre-stored in the driving chip, upon reception of the first enabling signal, where the unlocking background image indicates a position for lines unlocking; the lines recognizing chip acquires lines data upon reception of the second enabling signal, and provides a master controller with the acquired lines data; and the master controller compares the acquired lines data with pre-stored lines data upon reception of the lines data to enable lines unlocking. With this method, the number of times that the driving chip and the lines recognizing chip interactively communicate information with the master controller can be reduced to thereby improve a response speed of lines recognition, and lower power consumption of the master controller.

Optionally in the lines unlocking method according to the embodiments of the disclosure, the touch pressure detector determines whether it is triggered, in the operation S201 as follows: when the display screen is unlocked, the touch pressure detector detects a change in pressure in real time; and the touch pressure detector determines that the touch pressure detector is triggered, upon determining that a value of the change in pressure is greater than a preset pressure threshold.

In the lines unlocking method according to the embodiments of the disclosure, when the display screen is unlocked, the display screen is generally in a sleep state or an Always On Display (AOD) mode. In this state, the touch pressure detector detects a change in pressure in real time, detects a change in pressure using a pressure sensor, and determines that the touch pressure detector is triggered, and enters a lines unlocking mode, when there is a change in pressure; or determines that the touch pressure detector is not triggered, when there is no change in pressure, that is, the value of the change in pressure is not above the preset pressure threshold.

Optionally in the lines unlocking method according to the embodiments of the disclosure, the driving chip drives the display screen to display the unlocking background image pre-stored in the driving chip, in the operation S202 particularly as follows: the driving chip drives the display screen from a first brightness display mode to a second brightness display mode, where a second brightness value of the second brightness display mode is greater than a first brightness value of the first brightness display mode; and the driving chip drives the display screen to display the unlocking background image pre-stored in the driving chip in the second brightness display mode.

Particularly in the lines unlocking method according to the embodiments of the disclosure, the lines data are generally acquired by acquiring reflected light from a lines through an optical structure arranged below the display screen, so there shall be sufficiently intensive light incident on the lines so that the intensity of the light reflected back by the lines can be acquired by the optical lines acquiring component to thereby make the lines data acquired more precisely. Accordingly a display brightness of the display screen shall be adjusted, e.g., adjusting the display brightness of the display screen from a first brightness value to a second brightness value, where the second brightness value is greater than the first brightness value, i.e., the first brightness display mode of the display screen shall be adjusted to a high-brightness display mode, so that the lines data can be acquired as needed.

Optionally in the lines unlocking method according to the embodiments of the disclosure, the master controller compares the acquired lines data with the pre-stored lines data upon reception of the lines data to enable lines unlocking, in the operation S204 particularly as follows: the master controller compares the acquired lines data with a plurality of sets of lines data pre-stored in the master controller; and the master controller enables unlocking when the acquired lines data match successfully with one of the plurality of pre-stored sets of lines data.

Particularly in the lines unlocking method according to the embodiments of the disclosure, comparing the acquired lines data with the plurality of sets of lines data pre-stored in the master controller particularly includes: comparing the acquired lines data with the plurality of pre-stored sets of lines data in a descending order of the numbers of times that the plurality of pre-stored sets of lines data match successfully with previously acquired lines data; and when the acquired lines data match successfully with one of the plurality of pre-stored sets of lines data, stopping the acquired lines data from being compared with the other pre-stored sets of lines data.

Here in the lines unlocking method according to the embodiments of the disclosure, the plurality of sets of lines data pre-stored in the master controller are sorted in a descending order of the numbers of times that they match successfully with previously acquired lines data. That is, if the number of times that a pre-stored set of lines data matches successfully with previously acquired lines data is larger, the pre-stored set of lines data will be sorted at a higher priority, and compared earlier with new lines data. When the acquired lines data match successfully with any one of the pre-stored sets of lines data, the acquired lines data will not be further compared with the other pre-stored sets of lines data. There is a higher probability of successful matching with a stored set of lines data at a higher priority, so the acquired lines data can match successfully with one of the pre-stored sets of lines data through a smaller number of lines comparisons to thereby improve the efficiency of successful lines matching, and shorten a period of time for lines unlocking.

Optionally in the lines unlocking method according to the embodiments of the disclosure, after unlocking is enabled when the acquired lines data match successfully with one of the plurality of pre-stored sets of lines data, the method further includes: updating the numbers of times that the plurality of pre-stored sets of lines data match successfully with previously acquired lines data; and sorting the numbers of times that the plurality of pre-stored sets of lines data match successfully with previously acquired lines data, in a descending order.

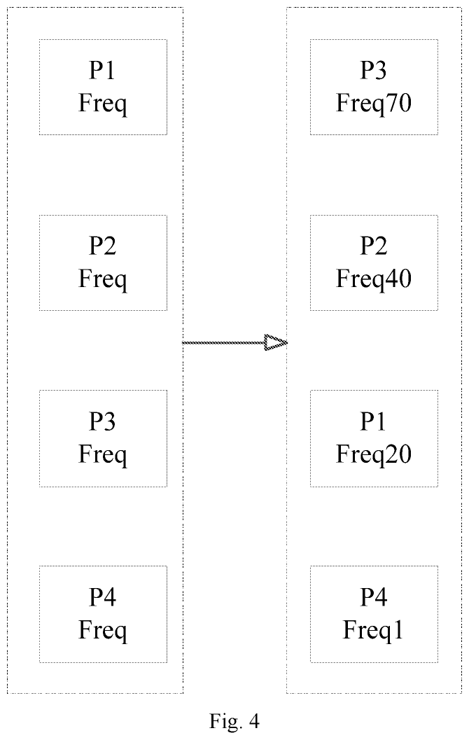

As illustrated in FIG. 4, in the lines unlocking method according to the embodiments of the disclosure, a plurality of sets of lines data are pre-stored in the master controller, and although four sets of lines data (i.e. P1, P2, P3, and P4) are pre-stored as illustrated in FIG. 4 by way of an example, the embodiments of the disclosure will not be limited to four sets of lines data.

Initially, the first set of lines data P1, the second set of lines data P2, the third set of lines data P3, and the fourth set of lines data P4 are arranged in order. Since none of them matches with any acquired lines data, all the numbers of times Freq that they match successfully with acquired lines data are 0. After they are compared with acquired lines data for a number of times, Freq of a pre-stored set of lines data is incremented by 1 each time it matches successfully with acquired lines data, that is, the numbers of times that the plurality of pre-stored sets of lines data match successfully with acquired lines data are updated, and sorted in a descending order.

As illustrated in FIG. 4, after the pre-stored sets of lines data are compared with acquired lines data for a number of times, the number of times Freq that the first set of lines data P1 matches successfully with acquired lines data is 20, the number of times Freq that the second set of lines data P2 matches successfully with acquired lines data is 40, the number of times Freq that the third set of lines data P3 matches successfully with acquired lines data is 70, and the number of times Freq that the fourth set of lines data P4 matches successfully with acquired lines data is 1,

So after the four sets of lines data are compared with acquired lines data for a number of times, they are sorted in the order of the third set of lines data P3, the second set of lines data P2, the first set of lines data P1, and the fourth set of lines data P4. While matching acquired lines data next time, the acquired lines data is firstly compared with the third set of lines data P3, and if the acquired lines data match successfully with the third set of lines data P3, unlocking will be enabled, and the acquired lines data will not be further compared with the other sets of lines data; if the acquired lines data fail to match with the third set of lines data P3, the acquired lines data will be further compared with the second set of lines data P2, etc., although a repeated description thereof will be omitted here.

Based upon the same inventive idea, some embodiments of the disclosure further provide a lines unlocking system including a touch pressure detector, a driving chip, a lines recognizing chip, and a master controller.

The touch pressure detector is configured to provide the driving chip with a first enabling signal, and the lines recognizing chip with a second enabling signal upon determining that the touch pressure detector is triggered.

The driving chip is configured to drive a display screen to display an unlocking background image pre-stored in the driving chip, upon reception of the first enabling signal, where the unlocking background image indicates a position for lines unlocking.

The lines recognizing chip is configured to acquire lines data upon reception of the second enabling signal, and to provide the master controller with the acquired lines data.

The master controller is configured to compare the acquired lines data with pre-stored lines data upon reception of the acquired lines data to enable lines unlocking.

Optionally in the lines unlocking system above according to the embodiment of the disclosure, the touch pressure detector is configured: when the display screen is unlocked, to detect a change in pressure in real time; and to determine that the touch pressure detector is triggered, upon determining that a value of the change in pressure is greater than a preset pressure threshold.

Optionally in the lines unlocking system above according to the embodiment of the disclosure, the driving chip is configured: to drive the display screen from a first brightness display mode to a second brightness display mode, where a second brightness value of the second brightness display mode is greater than a first brightness value of the first brightness display mode; and to drive the display screen to display the unlocking background image pre-stored in the driving chip in the second brightness display mode.

Optionally in the lines unlocking system above according to the embodiments of the disclosure, the master controller is configured: to compare the acquired lines data with a plurality of sets of lines data pre-stored in the master controller; and to enable unlocking when the acquired lines data match successfully with one of the plurality of pre-stored sets of lines data.

Optionally in the lines unlocking system above according to the embodiments of the disclosure, the master controller is further configured: to compare the acquired lines data with the plurality of pre-stored sets of lines data in a descending order of the numbers of times that the plurality of pre-stored sets of lines data match successfully with previously acquired lines data; and when the acquired lines data match successfully with one of the plurality of pre-stored sets of lines data, to stop the acquired lines data from being compared with the other pre-stored sets of lines data.

Optionally in the lines unlocking system above according to the embodiments of the disclosure, the master controller is further configured: to update the numbers of times that the plurality of pre-stored sets of lines data match successfully with previously acquired lines data after the acquired lines data match successfully with one of the plurality of pre-stored sets of lines data; and to sort the numbers of times that the plurality of pre-stored sets of lines data match successfully with previously acquired lines data, in a descending order.

Optionally in the lines unlocking system above according to the embodiment of the disclosure, the lines recognizing chip is connected with the master controller via a Serial Peripheral Interface (SPI) serial interface. Of course, the lines recognizing chip can alternatively be connected with the master controller via any other serial interface as long as the lines recognizing chip can communicate normally with the master controller, although the embodiment of the disclosure will not be limited thereto.

Optionally in the lines unlocking system above according to the embodiment of the disclosure, the touch pressure detector is connected respectively with the driving chip and the lines recognizing chip via one or more enabling signal interfaces. Of course, the touch pressure detector can be connected respectively with the driving chip and the lines recognizing chip via any other interfaces as long as the driving chip and the lines recognizing chip can communicate normally with the touch pressure detector, although the embodiment of the disclosure will not be limited thereto.

Particularly the principle of the lines recognizing system according to the embodiment above of the disclosure is the same as the principle of the lines recognizing method according to the embodiment above of the disclosure, so reference can be made to the principle of the lines recognizing method according to the embodiment above of the disclosure for details of the principle of the lines recognizing system, so a repeated description thereof will be omitted here.

Based upon the same inventive idea, an embodiment of the disclosure further provides a display device including the lines recognizing system according to any one of the embodiments above of the disclosure.

Here the display device can be a mobile phone, a tablet computer, or any other display device to be lines-unlocked, although the embodiments of the disclosure will not be limited thereto.

In summary, in the lines unlocking method, the lines unlocking system, and the display device according to the embodiments of the disclosure, the lines unlocking method includes: a touch pressure detector provides a driving chip with a first enabling signal, and a lines recognizing chip with a second enabling signal upon determining that the touch pressure detector is triggered; the driving chip drives the display screen to display an unlocking background image pre-stored in the driving chip, upon reception of the first enabling signal, where the unlocking background image indicates a position for lines unlocking; the lines recognizing chip acquires lines data upon reception of the second enabling signal, and provides the master controller with the acquired lines data; and the master controller compares the acquired lines data with pre-stored lines data upon reception of the lines data to enable lines unlocking. With this method, the number of times that the driving chip and the lines recognizing chip interactively communicate information with the master controller can be reduced to thereby improve a response speed of lines recognition, and lower power consumption of the master controller.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A lines unlocking method, comprising:
providing, by a touch pressure detector, a driving chip with a first enabling signal, and a lines recognizing chip with a second enabling signal upon determining that the touch pressure detector is triggered;
driving, by the driving chip, a display screen to display an unlocking background image pre-stored in the driving chip, upon reception of the first enabling signal, wherein the unlocking background image indicates a position for lines unlocking;
acquiring, by the lines recognizing chip, lines data, upon reception of the second enabling signal, and providing a master controller with the acquired lines data; and
comparing, by the master controller, the acquired lines data with pre-stored lines data upon reception of the acquired lines data to enable lines unlocking.

2. The lines unlocking method according to claim 1, wherein the determining that the touch pressure detector is triggered comprises:
when the display screen is unlocked, detecting, by the touch pressure detector, a change in pressure in real time; and
determining that the touch pressure detector is triggered, upon determining that a value of the change in pressure is greater than a preset pressure threshold.

3. The lines unlocking method according to claim 1, wherein the driving, by the driving chip, the display screen to display the unlocking background image pre-stored in the driving chip comprises:
driving, by the driving chip, the display screen from a first brightness display mode to a second brightness display mode, wherein a second brightness value of the second brightness display mode is greater than a first brightness value of the first brightness display mode; and
driving, by the driving chip, the display screen to display the unlocking background image pre-stored in the driving chip in the second brightness display mode.

4. The lines unlocking method according to claim 1, wherein the comparing, by the master controller, the acquired lines data with the pre-stored lines data upon reception of the acquired lines data to enable lines unlocking comprises:
comparing the acquired lines data with a plurality of sets of lines data pre-stored in the master controller; and
enabling unlocking when the acquired lines data match successfully with one of the plurality of pre-stored sets of lines data.

5. The lines unlocking method according to claim 4, wherein the comparing the acquired lines data with the plurality of sets of lines data pre-stored in the master controller comprises:
comparing the acquired lines data with the plurality of pre-stored sets of lines data in a descending order of the numbers of times that the plurality of pre-stored sets of lines data match successfully with previously acquired lines data; and
when the acquired lines data match successfully with one of the plurality of pre-stored sets of lines data, stopping the acquired lines data from being compared with the other pre-stored sets of lines data.

6. The lines unlocking method according to claim 4, wherein after unlocking is enabled when the acquired lines data match successfully with one of the plurality of pre-stored sets of lines data, the method further comprises:
updating the numbers of times that the plurality of pre-stored sets of lines data match successfully with previously acquired lines data; and
sorting the numbers of times that the plurality of pre-stored sets of lines data match successfully with previously acquired lines data, in a descending order.

7. A lines unlocking system, comprising a touch pressure detector, a driving chip, a lines recognizing chip, and a master controller, wherein:
the touch pressure detector is configured to provide the driving chip with a first enabling signal, and the lines recognizing chip with a second enabling signal upon determining that the touch pressure detector is triggered;
the driving chip is configured to drive a display screen to display an unlocking background image pre-stored in the driving chip, upon reception of the first enabling signal, wherein the unlocking background image indicates a position for lines unlocking;
the lines recognizing chip is configured to acquire lines data upon reception of the second enabling signal, and to provide the master controller with the acquired lines data; and
the master controller is configured to compare the acquired lines data with pre-stored lines data upon reception of the acquired lines data to enable lines unlocking.

8. The lines unlocking system according to claim 7, wherein the touch pressure detector is configured:
when the display screen is unlocked, to detect a change in pressure in real time; and
to determine that the touch pressure detector is triggered, upon determining that a value of the change in pressure is greater than a preset pressure threshold.

9. The lines unlocking system according to claim 7, wherein the driving chip is configured:
to drive the display screen from a first brightness display mode to a second brightness display mode, wherein a second brightness value of the second brightness display mode is greater than a first brightness value of the first brightness display mode; and
to drive the display screen to display the unlocking background image pre-stored in the driving chip in the second brightness display mode.

10. The lines unlocking system according to claim 7, wherein the master controller is configured:
to compare the acquired lines data with a plurality of sets of lines data pre-stored in the master controller; and
to enable unlocking when the acquired lines data match successfully with one of the plurality of pre-stored sets of lines data.

11. The lines unlocking system according to claim 10, wherein the master controller is further configured:
to compare the acquired lines data with the plurality of pre-stored sets of lines data in a descending order of the numbers of times that the plurality of pre-stored sets of lines data match successfully with previously acquired lines data; and
when the acquired lines data match successfully with one of the plurality of pre-stored sets of lines data, to stop the acquired lines data from being compared with the other pre-stored sets of lines data.

12. The lines unlocking system according to claim 10, wherein the master controller is further configured:
to update the numbers of times that the plurality of pre-stored sets of lines data match successfully with previously acquired lines data after the acquired lines data match successfully with one of the plurality of pre-stored sets of lines data; and
to sort the numbers of times that the plurality of pre-stored sets of lines data match successfully with previously acquired lines data, in a descending order.

13. The lines unlocking system according to claim 7, wherein the lines recognizing chip is connected with the master controller via a Serial Peripheral Interface (SPI).

14. The lines unlocking system according to claim 7, wherein the touch pressure detector is connected respectively with the driving chip and the lines recognizing chip via an enabling signal interface.

15. A display device, comprising the lines unlocking system comprising a touch pressure detector, a driving chip, a lines recognizing chip, and a master controller, wherein:
the touch pressure detector is configured to provide the driving chip with a first enabling signal, and the lines recognizing chip with a second enabling signal upon determining that the touch pressure detector is triggered;
the driving chip is configured to drive a display screen to display an unlocking background image pre-stored in the driving chip, upon reception of the first enabling signal, wherein the unlocking background image indicates a position for lines unlocking;
the lines recognizing chip is configured to acquire lines data upon reception of the second enabling signal, and to provide the master controller with the acquired lines data; and the master controller is configured to compare the acquired lines data with pre-stored lines data upon reception of the acquired lines data to enable lines unlocking.

16. The display device according to claim 15, wherein the touch pressure detector is configured:
when the display screen is unlocked, to detect a change in pressure in real time; and to determine that the touch pressure detector is triggered, upon determining that a value of the change in pressure is greater than a preset pressure threshold.

17. The display device according to claim 15, wherein the driving chip is configured:
to drive the display screen from a first brightness display mode to a second brightness display mode, wherein a second brightness value of the second brightness display mode is greater than a first brightness value of the first brightness display mode; and
to drive the display screen to display the unlocking background image pre-stored in the driving chip in the second brightness display mode.

18. The display device according to claim 15, wherein the master controller is configured:
to compare the acquired lines data with a plurality of sets of lines data pre-stored in the master controller; and
to enable unlocking when the acquired lines data match successfully with one of the plurality of pre-stored sets of lines data.

19. The display device according to claim 18, wherein the master controller is further configured:
to compare the acquired lines data with the plurality of pre-stored sets of lines data in a descending order of the numbers of times that the plurality of pre-stored sets of lines data match successfully with previously acquired lines data; and
when the acquired lines data match successfully with one of the plurality of pre-stored sets of lines data, to stop the acquired lines data from being compared with the other pre-stored sets of lines data.

20. The display device according to claim 18, wherein the master controller is further configured:
to update the numbers of times that the plurality of pre-stored sets of lines data match successfully with previously acquired lines data after the acquired lines data match successfully with one of the plurality of pre-stored sets of lines data; and
to sort the numbers of times that the plurality of pre-stored sets of lines data match successfully with previously acquired lines data, in a descending order.
